(19) United States
(12) Patent Application Publication
(10) Pub. No.: US 2025/0350177 A1
(43) Pub. Date: Nov. 13, 2025

(54) FERROMAGNETIC SPACER FOR PRINTED CIRCUIT BOARD AXIAL FLUX MACHINE

(71) Applicant: Steering Solutions IP Holding Corporation, Saginaw, MI (US)

(72) Inventors: Anik Chowdhury, Auburn Hills, MI (US); Alejandro Pina Ortega, Midland, MI (US); Rong Yang, Troy, MI (US); Shuvajit Das, Sterling Heights, MI (US)

(21) Appl. No.: 19/193,012

(22) Filed: Apr. 29, 2025

Related U.S. Application Data
(60) Provisional application No. 63/645,188, filed on May 10, 2024.

(51) Int. Cl. H02K 21/24; H02K 1/18; H02K 1/2798; H02K 3/26

(52) U.S. Cl. CPC H02K 21/24; H02K 1/182; H02K 1/2798; H02K 3/26

(57) ABSTRACT

An axial flux machine includes a back iron. The axial flux machine also includes at least one permanent magnet secured to the back iron. The axial flux machine further includes a stator comprising at least a pair of printed circuit board coils. The axial flux machine yet further includes a ferromagnetic spacer secured to the stator and disposed between the pair of printed circuit board coils.

### CROSS-REFERENCE TO RELATED APPLICATION

This application claims the benefits of priority to U.S. Provisional Patent Application Ser. No. 63/645,188, filed May 10, 2024, the disclosure of which is incorporated by reference herein in its entirety.

### FIELD OF THE INVENTION

The disclosure relates to axial flux machines and, more particularly, to a ferromagnetic spacer disposed between printed circuit boards disposed in an axial flux machine.

### BACKGROUND

Permanent magnet synchronous machines (PMSMs) are used in automotive applications ranging from steering to traction for their high torque and power densities. PMSMs are also applied to electric power steering (EPS) and steer by-wire (SbW) systems. The SbW system is an evolution of the EPS system, in which there is no mechanical coupling between the handwheel and the steering rack. The SbW system may include multiple actuators, such as a handwheel actuator (HWA) and a roadwheel actuator (RWA). The SbW HWA experiences second quadrant motor operation which provides a feedback torque—as opposed to assist torque which is provided in an EPS system—to the driver in order to ensure realistic steering feel.

Conventionally, radial flux machines (RFMs) are used in SbW HWA motors. However, it is possible to use different machine topologies which can improve the performance compared to RFMs. One such topology is an axial flux machine (AFM) design. The fundamental differences between the RFM and the AFM are the magnetic flux path of the machines and the configuration of their rotors and stators. In RFM applications, the rotor cannot reach the outer diameter of the machine, while in AFM applications the rotor can reach the outer diameter of the machine. AFM rotors are substantially flat, which improves the power density of the machines compared to RFMs. However, manufacturing AFMs poses challenges when compared to RFMs.

Conventional RFM winding and stator lamination methods can be directly used in AFM topologies. However, to further improve AFMs, printed circuit boards (PCBs) can be used as a winding topology, which makes manufacturing the machines easier. PCBs can be directly applied to a back iron of the stators which helps to eliminate the usage of stator tooth laminations. Usually, this topology is called slotless because no usage slots are present in the stators. Slotless structures use less steel, which helps to reduce the overall weight of the machine. Moreover, as the magnets are not facing any steel structure directly, a slotless structure has zero cogging which helps to reduce the cogging torque, improves the torque ripple performance of the machine, makes the machine linear, and makes the machine exhibit minimum torque ripple. Usually, PCB AFMs are slotless machines containing no ferromagnetic material on the stator side. However, in applications where PCBs are stacked back-to-back, a ferromagnetic material on the stator side can improve the performance of the system. PCBs are stacked back-to-back for further elimination of the steel weight from the stators. Two PCBs are stacked in between two rotors which is considered a single stage. Multiple stages of the machines can be stacked on each other to increase the output power of the machine. One possible configuration of the PCB AFM includes stacking two back-to-back PCB AFMs in a double back-to-back configuration, which doubles the power output as compared to one back-to-back PCB AFM. In such configurations, as the two back-to-back PCBs are stacked on each other, it is possible to use a single or dual ECU configuration while positioning the coils in different sets of arrangements. In one configuration, 12s8p is chosen. As a result, every PCB has twelve coils. Multiple winding arrangements are possible among these coils. Alternatively, the PCB AFMs can be configured as a single wound machine. Back-to-back PCB AFMs create a tight air gap between neighboring PCBs, which results in increased magnetic flux leakage between the two neighboring PCBs. This tight air gap further results in increased excess heat energy being retained by the PCB AFM.

Both single back-to-back PCB AFMs and double back-to-back PCB AFMs need to be isolated in some manner to avoid electrical shorting between PCBs and improve thermal performance.

### SUMMARY OF THE DISCLOSURE

According to one aspect of the disclosure, an axial flux machine includes a back iron. The axial flux machine also includes at least one permanent magnet secured to the back iron. The axial flux machine further includes a stator comprising at least a pair of printed circuit board coils. The axial flux machine yet further includes a ferromagnetic spacer secured to the stator and disposed between the pair of printed circuit board coils.

According to another aspect of the disclosure, an axial flux machine includes a back iron. The axial flux machine also includes at least one permanent magnet secured to the back iron. The axial flux machine further includes a stator comprising at least a pair of printed circuit board coils. The axial flux machine yet further includes a spacer secured to the stator and disposed between the pair of printed circuit board coils, wherein the spacer is a ring formed of at least one ring segment and the spacer has a spacer thickness which is less than a thickness of each of the printed circuit board coils.

These and other advantages and features will become more apparent from the following description taken in conjunction with the drawings.

### BRIEF DESCRIPTION OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an isometric view of a portion of an axial flux machine (AFM) having a spacer according to one aspect of the disclosure;

FIG. 2A is a perspective view of the spacer disposed between adjacent sets of printed circuit board coils;

FIG. 2B is a plan view of a portion of the spacer according to one aspect of the disclosure;

FIG. 3 is a plan view of a portion of the spacer according to another aspect of the disclosure;

FIG. 4A is a plan view of a portion of the spacer according to another aspect of the disclosure;

FIG. 4B is a plan view of a portion of the spacer according to another aspect of the disclosure;

FIG. 5A is a plan view of a portion of the spacer according to another aspect of the disclosure;

FIG. 5B is a plan view of a portion of the spacer according to another aspect of the disclosure;

FIG. 5C is a plan view of a portion of the spacer according to another aspect of the disclosure; and

FIG. 6 is a plan view of a portion of the spacer according to another aspect of the disclosure.

### DETAILED DESCRIPTION

The terminology used herein is for the purpose of describing particular embodiments only and not intended to be limiting. As used herein, the term “and/or” includes any and all combinations of one or more of the associated listed items. As used herein, the singular forms “a,” “an,” and “the” are intended to include the plural forms as well as the singular forms of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be understood that some techniques and steps of the invention are disclosed without connection to each other. Even so, each of these has one or more individual benefits and each can also be used in conjunction with one, more, or all the other disclosed techniques. Therefore, this disclosure may refrain from repeating every possible combination or the individual steps. Those combinations are still within the scope of this specification.

Unless otherwise defined, all terms used herein have the same meaning as commonly understood by one having ordinary skill in the art in the field wherein this invention belongs. It will be understood that terms such as those defined in commonly used dictionaries should be interpreted as having the meaning consistent with the relevant art rather than being interpreted in an idealized or overly formal sense, unless defined otherwise in this disclosure.

A spacer apparatus and method for use is described herein. In the following description, for explanatory purposes, details are set forth which provide a thorough understanding of the invention. It should be noted that the invention may be practiced without one or more of these specific details.

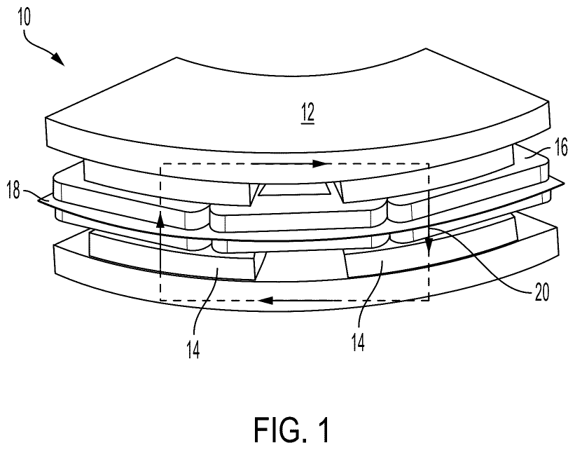

The disclosed embodiments will now be described by referencing the appended figures representing various embodiments. FIG. 1 depicts a portion of a printed circuit board (PCB) axial flux machine (AFM) 10. The illustrated AFM 10 includes two sets of PCB coils 16 stacked in what is referred to as a back-to-back configuration. AFMs comprise a set of both coils and magnets. Traditional AFM coils comprise copper wire windings, through which electric current is carried. When this current passes through a magnetic field, an oppositional force is created. The AFM coils are fixed to a housing which is stationary relative to permanent magnets 14. The oppositional force created between the permanent magnets 14 and the AFM coils are allowed to translate into torque. This is because the permanent magnets 14 are affixed to a shaft via a mechanical coupling to a bearing which is mechanically coupled to the shaft. The rotational motion of the permanent magnets 14 creates a torque. Copper winding coils necessitate a more three-dimensional coil structure because the coil must be stacked in a winding configuration. This means that an AFM using copper winding coils must take up more three-dimensional space than if the coils could be flattened. More space is needed because the copper winding takes on a cylindrical shape. The cylindrical shape must be affixed to a base, which can also be cylindrical. Since multiple windings are used, each winding's cylindrical base must be connected by material. The gaps between the bases are referred to as slots, and therefore its AFM configuration is referred to as slotted. Coils are effectively flattened by utilizing the illustrated PCB coils 16. PCB coils 16 are a more compact method of carrying electric current. PCB coils 16 are still electrical coils, but configurations with PCB coils remove the need for cylindrical bases. The current carrying principle is the same in a PCB coil 16 as a wound coil in that current is carried through the coil and through a magnetic field to create oppositional force. Such a PCB AFM 10 is referred to as slotless, because slotted AFMs use vertical windings which necessitate a grooved or slotted stator upon which windings are mounted.

Since the necessary configuration of an AFM is that a coil rests opposite a permanent magnet 14, the AFM can be symmetrically copied about the coil to create a back-to-back configuration. This saves space by creating less encasing material within the AFM. This back-to-back configuration comprises at least one permanent magnet 14 opposite at least one set of coils, then at least one second coil opposite the at least one coil, and finally a second at least one permanent magnet 14 opposite the at least one second coil. The back-to-back PCB configuration reduces the usage of thick stator back iron and reduces the overall weight and improves the power density of the system. However, due to the large airgap introduced due to multiple back to back to back PCB can introduce leakage flux and reduces the some output torque of the machine.

In some embodiments, the AFM 10 comprises a rotor back iron 12. The rotor back iron 12 is a solid piece of material which acts as a support for the inner permanent magnets 14. The rotor back iron 12 may be made of any solid material, but is typically made of iron, steel, aluminum, or another metal. The rotor back iron 12 acts to encase the AFM. The rotor back iron 12 reaches to the shaft (not shown) of the AFM, around which the rotor spins to provide feedback torque to a user. The rotor's spinning is accomplished by being attached to a bearing's outer diameter. The bearing's inner diameter is attached to the shaft. The rotor back iron 12 is substantially disc shaped. Permanent magnets 14 are permanently affixed to the back iron 12 by means of adhesive, pressing, fastener, or other means of connection. In one embodiment, four permanent magnets 14 are affixed to one side of the rotor back iron 12. In another embodiment, eight permanent magnets 14 are affixed to one side of the rotor back iron 12. These permanent magnets 14 are placed in alternating order, such that a positive permanent magnet 14 is surrounded by two negative permanent magnets 14 and vice versa. The permanent magnets 14 are shaped to fit into the rotor back iron's 12 disc shape. To accomplish this, the permanent magnet 14 takes on the shape of a rectangle with curved sides. The curved sides of the rectangle are tangentially parallel. Both the rotor back iron 12 and the permanent magnets 14 are substantially flat. The combination of the two creates the rotor. Since both the rotor and permanent magnets 14 are substantially flat, the rotor comprises a disc shape. One rotor is positioned opposite a replica rotor.

PCB coils 16 are positioned opposite the permanent magnets 14 but do not touch one another. The two sets of PCB coils 16 are separated from another set of PCB coils 16 by a spacer 18. The PCB coils 16 are permanently fixed to the spacer 18 by means of adhesive, pressing, fastener, or other means of connection. The PCB coils 16 may take a trapezoidal shape around their perimeter. The PCB coils 16 may be shaped such that the shape of the outer perimeter is not present on the inside of the coil as an aperture 24. This embodies a trapezoidal ring shape to the PCB coils 16. The connected PCB coils 16 and spacer 18 comprise a stator, which stays still relative to a rotor and braces the assembly against forces originating from rotational energy. The rotor rotates relative to the stator. The rotor is connected to the housing. Typically, the rotor and housing are attached by the PCB coils 16. In some embodiments, the stator and rotor functions may be reversed, meaning the stator can be fixed to the shaft and rotate, while the rotor is fixed to the housing and stays still relative to the stator. The resulting magnetic flux path 20 of the permanent magnet 14 orientation is shown in FIG. 1. The magnetic flux path 20 is a result of how the permanent magnets 14 are configured. To further compound the advantages of the back-to-back configuration, any number of PCB coils 16 can be stacked together within one set of permanent magnets 14. This results in a stator separated by multiple spacers 18. In one embodiment, four sets of PCB coils 16 are stacked together separated by three spacers 18.

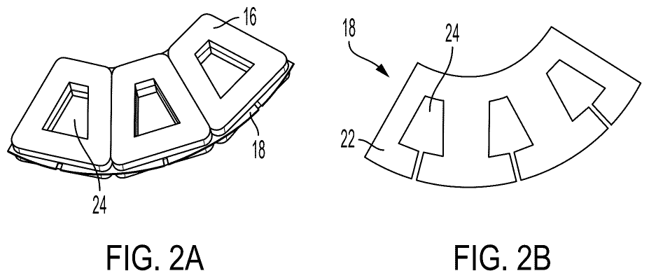

Spacers 18 may be included within the multiple spacer 18 embodiment variably. This means that one or more of the spacers 18 within the multiple spacer 18 assembly may include apertures 24, as shown in FIGS. 2A and 2B. In such an embodiment, the PCB coils 16 have substantially corresponding apertures aligned with the apertures 24 of the spacer 18. Alternatively, one or more spacers 18 within the multiple spacer 18 assembly may not include one or more apertures 24, as shown in embodiments of other Figures.

FIG. 2B depicts a flat view of approximately one fourth of the circular spacer 18. The spacer 18 may comprise a ferromagnetic material. Alternatively, the spacer 18 may comprise a metal such as steel, iron, or aluminum. The spacer 18 may be thin relative to its flat surface. In particular, the spacer 18 is thinner than the PCB coils 16. The spacer 18 may comprise one or more tangible portions 22. The tangible portions 22 are full of whichever material comprises the spacer 18. The spacer 18 may further comprise one or more apertures 24. The apertures 24 comprise an opening through the face of the spacer 18. The opening of the apertures 24 goes through the surface of the spacer 18 completely. The apertures 24 may be machined, formed, or already present in the manufacture of the spacer 18. The apertures 24 may take the shape of apertures of the PCB coils 16 or the PCB coils 16 themselves. The apertures 24 may be shaped to create a bicycle spoke pattern on the spacer 18. The bicycle spoke pattern means that the apertures 24 comprise shapes positioned distal from the circular center of the spacer 18 to the spacer's 18 edge, repeatedly and symmetrically throughout the circumference of the spacer 18. The apertures 24 may take on an alternative orientation, including being positioned such that their longways is at an angle from the center. The apertures 24 may take the form of any known shape, including but not limited to quadrilateral, triangular, polygonal, and circular. As such, the apertures 24 may not have a longways. In such cases, the apertures 24 may be placed at any radial and/or angular position on the spacer 18 and at any orientation. The apertures 24 may reach to the edge of the spacer 18 furthest from its circular center, nearest to its circular center, both, or neither. The apertures 24 may improve electromagnetic, thermal, and/or mechanical performance of the PCB AFM 10. The electromagnetic flux improvements come in the form of mitigating magnetic flux from leaking to a neighboring PCB coil 16 from a nearby PCB coil 16. The apertures 24 may let magnetic flux take a more advantageous path such that less interference between PCB coils 16 occurs. Without implementing apertures 24, magnetic flux tends to interfere with neighboring PCBs coils 16. Implementing apertures 24 results in increased output torque. The apertures 24 may allow heat energy to dissipate more efficiently. Heat energy may dissipate more efficiently by escaping the stator body by moving along the spacer 18. The apertures 24 may improve the AFM's mechanical performance by reducing the weight of the rotor, thus allowing more efficient power usage. The more efficient power usage is exhibited by an increased output torque of the PCB AFM 10 as compared to an embodiment whose spacer 18 does not have apertures 24.

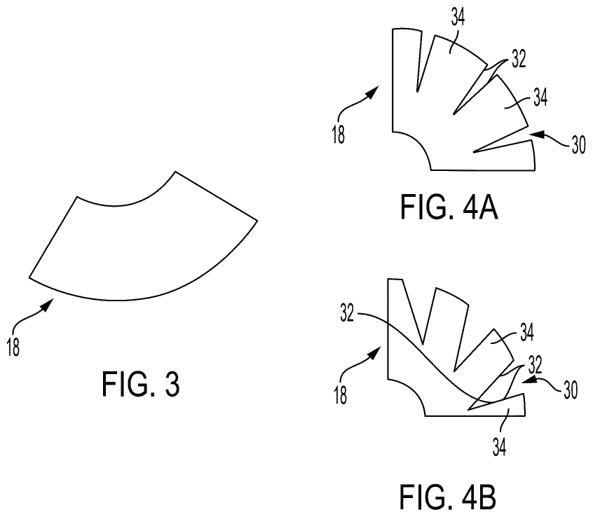

FIG. 3 depicts another embodiment of the spacer 18 without apertures 24. The spacer 18 is positioned within the AFM 10 in the manner disclosed above and provides similar benefits as that of the embodiments of FIGS. 1, 2A and 2B. The spacer may be substantially flat and disc-shaped. The spacer 18 functions to separate two sets of PCB coils 16 in back-to-back configuration. The spacer 18 may comprise a ferromagnetic material. Alternatively, the spacer 18 may comprise another metal such as aluminum or steel, iron, or resin. The spacer 18 may be thin relative to its flat surface. Creating a spacer 18 without apertures 24 may be advantageous due to manufacturing cost savings.

FIGS. 4A and 4B illustrate additional embodiments of the spacer 18. In particular, the spacer 18 may have what are referred to as V-shaped cutout regions 30. The cutout regions 30 are defined by edges 32 of adjacent segments 34 of the spacer 18.

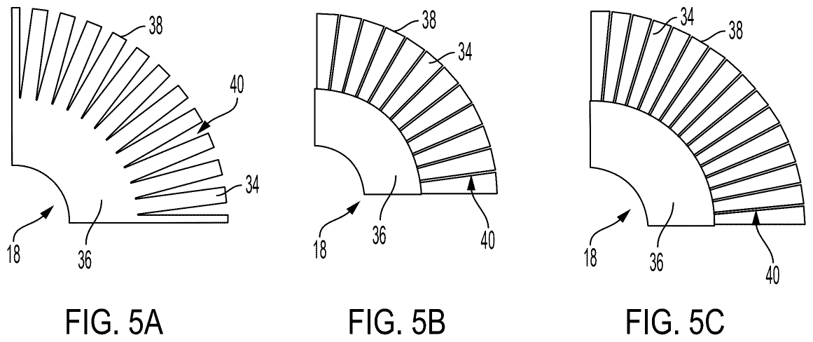

FIGS. 5A-5C illustrate additional embodiments of the spacer 18. In particular, the spacer 18 may be what is referred to as a multi-slot spacer. Embodiments of a multi-slot spacer include substantially identical segments 34 extending from an inner hub 36 to a radially outer tip 38. The substantially identical segments 34 define substantially identical slots 40 therebetween.

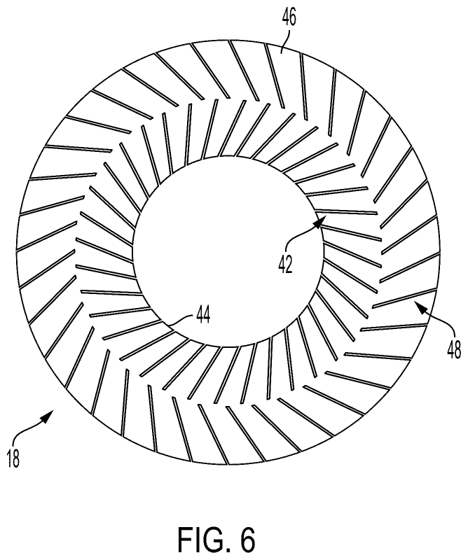

FIG. 6 illustrates an additional embodiment of the spacer 18. In particular, the spacer 18 may be what is referred to as a serpentine spacer. In the illustrated embodiment, a radially inner array of slots 42 are defined around the ring-shaped spacer 18. The radially inner array of slots 42 extend from the radially inner edge 44 of the spacer 18 to a radial location that is radially inward of the radially outer edge 46 of the spacer 18. Additionally, a radially outer array of slots 48 are defined around the ring-shaped spacer 18. The radially outer array of slots 48 extend from the radially outer edge 46 of the spacer 18 to a radial location that is radially inward of the radially outer edge 46 of the spacer 18. The radial location that each array of slots 42, 48 extends to away from their respective edges (i.e., inner and outer edges) may vary. The arrays of slots 42, 48 do not intersect and may be oriented in numerous contemplated directions in different embodiments.

The embodiments disclosed herein reduce cogging and increase output torque of the machines they are utilized within.

While the invention has been described in detail in connection with only a limited number of embodiments, it is to be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Moreover, any feature, element, component or advantage of any one embodiment can be used on any of the other embodiments. Accordingly, the invention is not to be seen as limited by the foregoing description.

What is claimed is:

1. An axial flux machine, comprising:
a back iron;
at least one permanent magnet secured to the back iron;
a stator comprising at least a pair of printed circuit board coils; and
a ferromagnetic spacer secured to the stator and disposed between the pair of printed circuit board coils.

2. The axial flux machine of claim 1, wherein the ferromagnetic spacer is a ring formed of at least one ring segment.

3. The axial flux machine of claim 2, wherein the ferromagnetic spacer defines one or more apertures.

4. The axial flux machine of claim 3, wherein at least one of the one or more apertures aligns with a corresponding aperture defined by at least one of the printed circuit board coils.

5. The axial flux machine of claim 2, wherein the ferromagnetic spacer comprises:
a radially inner edge defining a central opening;
a radially outer edge;
an array of radially inner slots extending from the radially inner edge; and
an array of radially outer slots extending from the radially outer edge.

6. The axial flux machine of claim 5, wherein an entirety of the radially outer slots are located radially outwardly of the radially inner slots.

7. The axial flux machine of claim 2, wherein the ferromagnetic spacer comprises:
a radially inner edge defining a central opening;
a radially outer edge; and
a plurality of V-shaped cutouts extending from the radially outer edge, wherein the plurality of V-shaped openings are circumferentially spaced from each other.

8. The axial flux machine of claim 2, wherein the ferromagnetic spacer comprises:
a radially inner edge defining a central opening;
a radially outer edge; and
a plurality of slots extending from the radially outer edge, wherein the plurality of slots are shaped identically and circumferentially spaced from each other.

9. The axial flux machine of claim 1, wherein the spacer has a spacer thickness which is less than a thickness of each of the printed circuit board coils.

10. An axial flux machine, comprising:
a back iron;
at least one permanent magnet secured to the back iron;
a stator comprising at least a pair of printed circuit board coils; and
a spacer secured to the stator and disposed between the pair of printed circuit board coils, wherein the spacer is a ring formed of at least one ring segment and the spacer has a spacer thickness which is less than a thickness of each of the printed circuit board coils.

11. The axial flux machine of claim 10, wherein the ferromagnetic spacer defines one or more apertures.

12. The axial flux machine of claim 11, wherein at least one of the one or more apertures aligns with a corresponding aperture defined by at least one of the printed circuit board coils.

13. The axial flux machine of claim 10, wherein the ferromagnetic spacer comprises:
a radially inner edge defining a central opening;
a radially outer edge;
an array of radially inner slots extending from the radially inner edge; and
an array of radially outer slots extending from the radially outer edge.

14. The axial flux machine of claim 13, wherein an entirety of the radially outer slots are located radially outwardly of the radially inner slots.

15. The axial flux machine of claim 10, wherein the ferromagnetic spacer comprises:
a radially inner edge defining a central opening;
a radially outer edge; and
a plurality of V-shaped openings extending from the radially outer edge, wherein the plurality of V-shaped openings are circumferentially spaced from each other.

16. The axial flux machine of claim 10, wherein the ferromagnetic spacer comprises:
a radially inner edge defining a central opening;
a radially outer edge; and
a plurality of slots extending from the radially outer edge, wherein the plurality of slots are shaped identically and circumferentially spaced from each other.
